(19) United States
(12) Patent Application Publication
(10) Pub. No.: US 2009/0261785 A1
(43) Pub. Date: Oct. 22, 2009

(54) METHOD FOR MANAGING A MODULAR POWER SOURCE

(76) Inventors: Mason Cabot, San Francisco, CA (US); Paul Durkee, San Francisco, CA (US); Mark Sherwood, Palo Alto, CA (US)

Correspondence Address: SCHOX PLC, 500 3rd Street, Suite 515, San Francisco, CA, 94107, US

(21) Appl. No.: 12/413,345

(22) Filed: Mar. 27, 2009

Related U.S. Application Data
(60) Provisional application No. 61/040,094, filed on Mar. 27, 2008.
(60) Provisional application No. 61/116,542, filed on Nov. 20, 2008.

(51) Int. Cl. H02J 7/00

(52) U.S. Cl. 320/134

(57) ABSTRACT

Disclosed is a method for management of a modular power source including the steps of setting a first operation threshold, selecting a module 10, retrieving data representative of the operating condition of the module 10, retrieving data representative of the time, storing the newly retrieved data, comparing the newly retrieved data to historical data representative of historical operating conditions of the module 10, determining a second operation threshold for the module 10 relative to the comparison, applying the second operation threshold for the module 10, and selecting the next module 10.

### CROSS-REFERENCE TO RELATED APPLICATIONS

This application claims the benefit of U.S. Application Nos. 61/040,094 (filed on 27 Mar. 2008) and 61/116,542 (filed on 20 Nov. 2008), which are both incorporated in their entirety by this reference.

### TECHNICAL FIELD

This invention relates generally to the portable power field, and more specifically to a new and useful method for managing a modular power source.

### BACKGROUND

As the market for applications that require large amounts of portable power grows, the need for efficient, safe, reliable, and high power density battery packs increases. In particular, electrically powered vehicles, such as passenger vehicles, all-terrain vehicles, motorcycles, and scooters, require exceptionally high levels of power to enable the vehicle to have a travel distance per charge that is comparable to present day gasoline powered vehicles. Within the class of mass produced electrical battery cells, lithium ion batteries have one of the highest energy densities. These batteries, which are most commonly used in laptop computers, are the most cost-effective in a relative small form factor. To create a suitable power supply for electrical transportation needs, however, relatively large numbers of these cells (on the order of hundreds or even thousands) must be grouped together. With such a large number of cells, management of power output and charge distribution within the system plays a considerable role in the overall performance of the cells. This holds true for any type of power source that may require a plurality of power modules 10, for example, other types of electrical cells or hydrogen fuel cells.

While “standardized” to some extent, every cell has slightly (or, in some extreme cases, significantly) different optimal operating conditions. Different manufacturers, different production runs, and different usage all contribute to the optimal operating condition of a cell. Management of current power sources, however, has been focused on the averages and has not exploited the subtle differences in the cells, which could yield considerable benefits in the overall performance of the cells within the power source. Thus, there is a need in the portable power field to create a method to manage a modular power source that is adaptable and accommodating to the variations that exist in the cells. This invention provides such a method.

### BRIEF DESCRIPTION OF THE FIGURES

FIG. 1 is a schematic representation of a preferred embodiment of the invention; and

FIGS. 2, 3, and 4 are schematic representations of different variations of the preferred embodiment of the invention shown in FIG. 1.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

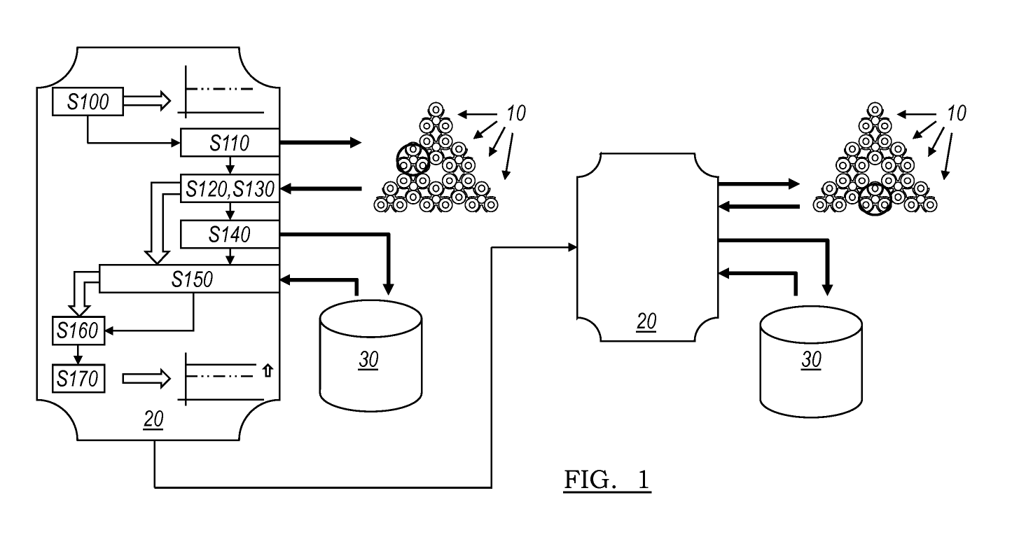

Because of the abundance of cell manufacturers and manufacturing conditions that exist for commercially available cells, cells generally vary in performance characteristics, optimal parameters for performance, and operational lifetime and operational trends. By monitoring the cell operation conditions (for example, actual voltage, current output, and temperature of the cells) of individual or groups of cells, hereafter called “modules 10,” within the power source during charge and discharge cycles, the overall performance of the power source may be improved. As shown in FIG. 1, the preferred embodiment of the invention includes the steps of setting a first operation threshold S100, selecting a first/next module 10 S110, retrieving data representative of the operating condition of the module 10 S120, retrieving data representative of the time S130, storing the newly retrieved data S140, comparing the newly retrieved data to previously stored data representative of the operating condition of the module 10 S150, determining a second operation threshold for the module 10 S160, and applying the appropriate operation threshold for the module 10 S170. At this point, the method preferably returns to selecting a next module 10 S110. This method is preferably applied to the power source when the power source is in use, for example, during charge and discharge. The method is preferably carried out using a processing unit 20, but may alternatively be carried out using any other suitable device.

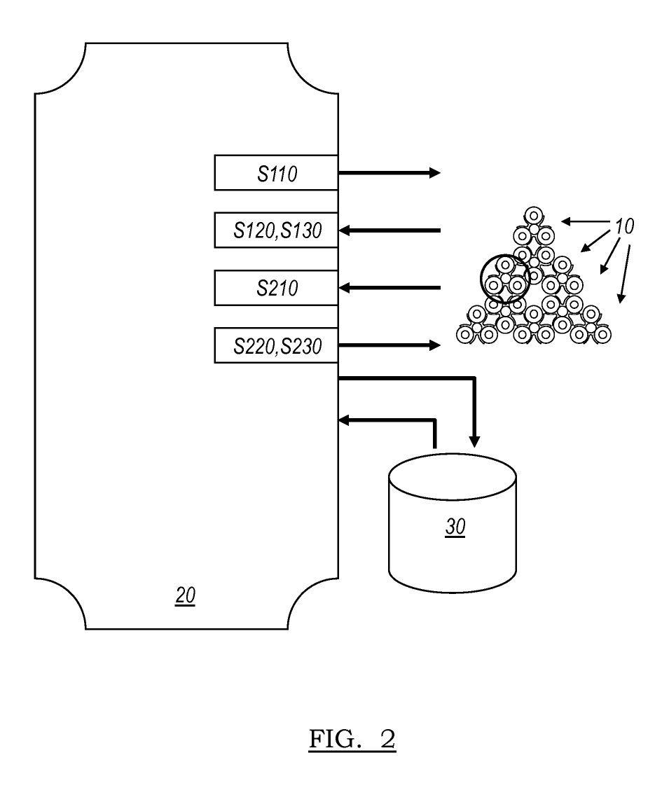

As shown in FIG. 2, the preferred embodiment also includes the steps of detecting the occurrence of an operating condition beyond an operation threshold S210, applying corrective action by adjusting the operation of the module 10 when such an event is detected S220, and maintaining the same operation of the module 10 when such an event is not detected S230. Detecting the occurrence of an operating condition beyond the operation threshold S210 is preferably conducted by the processing unit 20 and preferably includes the steps of retrieving the operation threshold data, comparing it to the first and/or the second operating condition from the newly retrieved data, and determining which of the operation threshold and the operating condition from the newly retrieved data have the higher magnitude. If the operating condition from the newly retrieved data has the higher magnitude, then the occurrence of a beyond-threshold operating condition is detected. Alternatively, Step S210 may compare the operation threshold and the operating condition from the newly retrieved data to determine which is the lower magnitude to detect the occurrence of a beyond-threshold operating condition. Adjusting the operation of the module 10 preferably includes disconnecting the module 10, reconnecting the module 10, adjusting the required power output of the module 10, adjusting the charge current supplied to the module 10, and/or adjusting the thermal regulation of the module 10. However, any other suitable adjustment may be applied as a corrective action.

Step S100 preferably includes setting an operation threshold for an individual module 10, but may alternatively include setting a general operation threshold for the power source. The first operation threshold may alternatively be applied to any other arrangement of modules 10 within the power source. In both variations, the first operation threshold, which is set in Step S100, is preferably reevaluated and preferably adjusted to best fit each individual module 10 in Steps S160 and S170, as described below. The first operation threshold may be set at the first use of the module 10, first use of the power source, first use after rearrangement or replacement of modules 10 within the power source, and/or at the beginning of each cycle of use of the module 10, for example, at the beginning of each charge cycle or discharge cycle. However, any other time suitable to the usage of the power source may be used to set the first operation threshold.

The first operation threshold is preferably a value and/or degree representing a level of operating condition that—if crossed—would be potentially harmful for the module 10 and/or other modules 10 within the power source. The first operation threshold may also include a safe level threshold that—if crossed—would be safe for the module 10 and/or the other modules 10 within the power source. The safe level threshold may be used to indicate the safe resumption of normal operation of a module 10 that had been detected as harmful and/or near failure. The first operation threshold is preferably a value for an operation parameter such as voltage, current, temperature, internal impedance, battery capacity, and/or time. The first operation threshold may alternatively be a value and/or degree for the difference between two data for a parameter. The first operation threshold may, however, be of any other type of data for any other applicable parameter suitable to monitoring the module 10. The first operation threshold is preferably set into the system (for example, by a technician, and/or by the manufacturer) directly and/or remotely, but may alternatively be derived by the system from historical operation data, the operating condition of the overall power source, and/or the age of the module 10 (for example, adjusting a preset operation threshold based on the age of the module 10). However, any other suitable method of setting or source for the first operation threshold may be used. The first operation threshold is preferably a value and/or degree, but may alternatively be a set of values and/or degrees that are relative to or a function of time, hereafter called “a trend.” When the first operation threshold is a trend, setting a first operation threshold S100 includes the steps of determining the time and selecting the operation threshold from the set of values and/or degrees based on the determined time. The trends may be based on historical operation data from charge and/or discharge cycles, manufacturer data for the module 10, battery type of the module 10, the age of the module 10, user inputted trend data, manufacturer inputted trend data, technician inputted trend data, an/or remotely inputted trend data. However, any other suitable source of trend data may be used. Any trend data that is obtained from prior charge and/or discharge cycles or from trends inputted prior to the current cycle are preferably adjusted for the age of the module 10 for the current cycle. For example, because an older module 10 has a higher likelihood to fail relative to a younger module 10, the operation thresholds for the older module 10 may be more conservative than for a younger module 10. In the case of using a value for the operation threshold for an operation parameter (such as temperature), the value for the operation threshold for temperature of an older module may be lower than that of a younger module 10 to trigger the application of corrective action sooner and safely protect the older module 10 from failure. However, any other suitable method of adjusting thresholds from trend data may be used.

Step S120 preferably includes retrieving a value and/or degree that is representative of an operation parameter of the module 10. The operation parameter is preferably voltage, current, temperature, internal impedance, battery capacity, and/or pressure. The data preferably includes values and/or degrees for a plurality of operation parameters, but may alternatively include one value and/or degree for a single operation parameter. However, any other parameter, data type, or number suitable to representing the operating condition of the module 10 may be used. Step S130 preferably includes retrieving a value and/or degree that is representative of the time. The time data is preferably relative to the initial use of the module 10, but may alternatively be time data relative to the first use after a charge cycle (such as the start of a discharge cycle); relative to the first use after a discharge cycle (such as the start of a charge cycle); relative to the first use after the system has been turned off; relative to a time mark set by the user, manufacturer, and/or technician; and/or relative to a remotely set time mark. However, any other time data suitable to the operation of the module 10 may be used.

In Step S140, which includes storing the newly retrieved data, the processing unit 20 preferably stores the data retrieved in Step S120 and Step S130 to a device with memory, for example, a hard-drive, flash memory, or any other suitable data storage device. The data storage device also preferably functions to transfer historical data to the processing unit 20 to be used in Step S150. The data storage device may include a plurality of divisions, for example, a first portion with smaller memory capacity than a second portion. The first portion is preferably used to store immediately useful data to increase the data transfer rate to the processing unit 20, while the second portion is preferably used to store other data used in managing the module 10 and the power source such as operating conditions stored from cycles of the module 10 and the power source prior to a certain time. However, any other suitable arrangement of memory within the data storage device may be used.

Step S150 preferably includes the processing unit 20 retrieving historical data of the module 10 from the data storage device and then evaluating the relationship between the historical data and the newly retrieved data of the module 10. The processing unit 20 may evaluate the relationship between the newly retrieved data and the historical data from the data stored from the data retrieval cycle prior to the current data retrieval cycle, evaluate the relationship between the newly retrieved data and each of a plurality of stored operation conditions within a time frame, and/or evaluate the relationship between the newly retrieved data and the average of a plurality of stored operation conditions within a time frame. The processing unit 20 may also evaluate the rate of change of the operating condition within a time frame using the historical and newly retrieved data. However, any suitable combination of data suitable to evaluation of the performance of the module 10 may be used.

When comparing the newly retrieved data to historical data S150, the processing unit 20 may also evaluate the newly retrieved data with the historical data to calculate new maximum, minimum, and average operating conditions for the module 10 and to substitute the new operating conditions in place of the previously calculated operating conditions for the module 10. The processing unit 20 preferably compares the newly retrieved data to the stored maximum operating condition for the module 10, determines the larger degree for the condition, and stores the larger degree as the maximum operating condition; compares the newly retrieved data to the stored minimum operating condition for the module 10, determines the smaller degree for the condition, and stores the smaller degree as the minimum operating condition; and incorporates the newly retrieved data to the historical data to evaluate a new average operating condition for the module 10. However, any other method to evaluate maximum, minimum, and average operating conditions for the module 10 may be used.

Step S160 preferably determines a second operation threshold that replaces the first operation threshold and increases the performance of the module 10. The second operation threshold preferably functions similar or identical to the first operation threshold, and is preferably used in the threshold evaluations of Step 210. The second operation threshold may alternatively work in tandem with the first operation threshold. For example, Step S210 may include using the second operation threshold as a warning operation level threshold that indicates that the module 10 is close to failure when the second operation threshold is surpassed while the first operation threshold may be used as a failure operation level threshold that indicates module 10 failure when the first operation threshold is surpassed. In this example, Step S212 may include the following corrective actions: when the second operation threshold is surpassed, adjustments may be made in the required output of the module 10, charge current supplied to the module 10, and/or the thermal regulation of the module 10 to attempt recovering the module 10 before failure; and when the first operation threshold is surpassed, the module 10 may be disconnected to prevent full module 10 failure that may adversely affect the rest of the power source. Alternatively, the first operation threshold may be used as the warning operation level threshold and the second operation threshold may be used as the failure operation level threshold. The second operation threshold may also be used as the safe level threshold mentioned above. However, any other combination of usage of the first and second operation thresholds suitable to managing the module 10 and the power source may be used.

Step S160, which includes determining a second threshold for the module 10, preferably includes determining an operation threshold that matches the average operating conditions of the module 10. In an example of a first variation, the module 10 may operate most efficiently at an average temperature that is higher than the average temperature for other modules 10 or of the overall power source. To allow the module 10 to continue to operate at this more efficient temperature without the processing unit 20 unnecessarily detecting the occurrence of beyond-threshold conditions and taking corrective action, Step S160 determines a higher temperature threshold for the module 10, thus allowing the module 10 to operate “normally” and at a higher efficiency. In a second variation, Step S160 may also determine a threshold for a module 10 to better protect the module 10 from failure. For example, in a module 10 where the rate of change of temperature is relatively fast, Step S160 determines a lower temperature threshold to trigger the processing unit 20 to implement corrective action sooner. In a third variation, the first operation threshold may be a conservative estimate of the optimal operation threshold for the module 10 and Step S160 may function to test a plurality of different operation thresholds until the optimal operation threshold that caters to the module 10 is found (ala an optimal seeking method). In a fourth variation, Step S160 functions to determine an operation threshold that accommodates the age of the module 10, for example, Step S160 may determine a lower temperature threshold than the average for a module 10 that is older.

In a first variation of Step S160, determining a second threshold for the module 10 uses a parameter-proximity threshold. In this variation, setting a first operation threshold S100 further includes setting a parameter-proximity threshold that indicates the minimum allowable difference between the operating condition of the module 10 and an operation threshold; comparing the newly retrieved data to previously stored data S150 includes evaluating historical data when operation beyond the parameter-proximity threshold is detected to determine whether the historical data indicates consistent normal operation while beyond the parameter-proximity threshold; and determining the appropriate operation threshold for the module 10 S160 includes determining an operation threshold that matches the operating condition when beyond-threshold operation is normal and maintaining the previous operation threshold when beyond-threshold operation is not normal. The test for normalcy at beyond-threshold conditions is preferably conducted at each occurrence of operating conditions beyond the parameter-proximity threshold, but may alternatively be conducted after several occurrences of operating conditions beyond the parameter-proximity threshold. When the data representative of the operating conditions includes values and/or degrees for a plurality of operation parameters, to determine normalcy, the processor will preferably determine which parameter is operating beyond the parameter-proximity threshold, evaluate the historical data to detect whether the operation parameter has been beyond parameter-proximity for a length of time, and evaluate the historical data for the other operation parameters to detect whether the other operation parameters have been operating within their respective parameter-proximity thresholds for the same length of time. If the other operation parameters are within their respective parameter-proximity thresholds, then the beyond threshold operation of the operation parameter in question is indicated as normal. If the other operation parameters show abnormalities, fluctuations, or inconsistencies, then the beyond threshold operation of the operation parameter in question is indicated as not normal. However, any other suitable test for operation normalcy may be used.

The parameter proximity threshold may also be a threshold used to measure deviation of the module 10 operating conditions from the average conditions of the power source, for example, the difference between the maximum, minimum, and average operating conditions of the module 10 and the average maximum, average minimum, and average operating conditions of the module 10s within the power source respectively. In this variation, setting the operation threshold S100 further includes setting a deviation threshold that indicates the maximum allowable deviation of the maximum, minimum, and average operating conditions of the module 10 from the maximum, minimum, and average operating conditions of the power source, respectively; the parameter-proximity threshold includes a deviation-proximity threshold that is used to indicate the minimum allowable difference between the operating conditions of the module 10 and the deviation threshold; and determining a second operation threshold S160 includes determining a new deviation threshold to match the operating condition when operation of the module 10 beyond the deviation-proximity threshold is normal and maintaining the previous deviation threshold when the operation of the module 10 beyond the deviation-proximity threshold is not normal.

In a second variation of Step S160, determining a second threshold for the module 10 uses a rate of change threshold. In this variation, setting a first operation threshold S100 further includes setting a rate of change threshold, and comparing the newly retrieved data to the previously stored data further includes evaluating a new rate of change of the operating condition using the newly retrieved. Also in this variation, determining the appropriate operation threshold for the module 10 includes determining an operation threshold of a first level when the rate of change of the operating condition is at a first value greater than the rate of change threshold and determining an operation threshold of a second level greater than the first level when the rate of change of the operating parameter is at a second value less than the rate of change threshold. Step S160 may also include determining a threshold of a third level greater than the second level when the rate of change of the operating condition is at a third value less than the second value and the rate of change threshold.

In a third variation of Step S160, determining a second threshold for the module 10 includes the steps of: increasing the operation threshold by a first differential, evaluating the effect of the increased threshold on the module 10 operating condition after a length of time has passed, increasing the operation threshold again by the first differential when the module 10 operating condition is not adversely affected, and decreasing the threshold by a second differential when the module 10 operating condition is adversely affected. These steps are preferably iterated until improvements in the operating condition are no longer observed and the optimal operation threshold is thus determined. For example, when applied to a charging cycle, the operation threshold is preferably of a charge time threshold. To prevent the risk of overcharging a module 10, the module 10 is removed from receiving charging current when a certain time is reached even if the desired charge voltage is not reached. The charge time threshold in this variation can be extended by a first differential at each charge cycle, then the power capacity of the module 10, temperature, and any other suitable charge operation parameter may be evaluated to determine whether the increase in charge time has improved the power capacity of the module 10 or any other aspects of the module 10, and if improvement or no change is observed, the charge time threshold is preferably increased again by the first differential. If, however, a negative effect on operation parameters is observed (for example, abnormal temperatures, or decreased capacity), the charge time threshold is preferably decreased by a second differential. Alternatively, if no improvement is observed over several increases of the charge time threshold over a period of time and there are no adverse effects, the processing unit 20 may determine to maintain the previous charge time threshold as the optimal charge time threshold for the module 10. The second differential is preferably larger than the first differential to quickly recover the module 10 and prevent failure, but may alternatively be equal to or smaller than the first differential.

In a fourth variation of Step S160, determining a second threshold for the module 10 uses the age of the module 10. In this variation, setting a first operation threshold S100 further includes setting a time threshold and determining a second threshold for the module 10 S160 determines whether the time data retrieved in Step S130 is greater than the time threshold. If the newly retrieved time data is larger than the time threshold, then Step S160 determines a new operation threshold that matches the age of the module 10. If the newly retrieved time is smaller than the time threshold, then Step S160 maintains the previous operation threshold.

The four aforementioned variations of Step S160 may be combined in any suitable arrangement to manage the module 10 and the power source and to determine a second operation threshold for the module 10. However, any other method and data suitable to managing the power source and module 10 and evaluating the second operation threshold for a module 10 using historical operating condition data may be used.

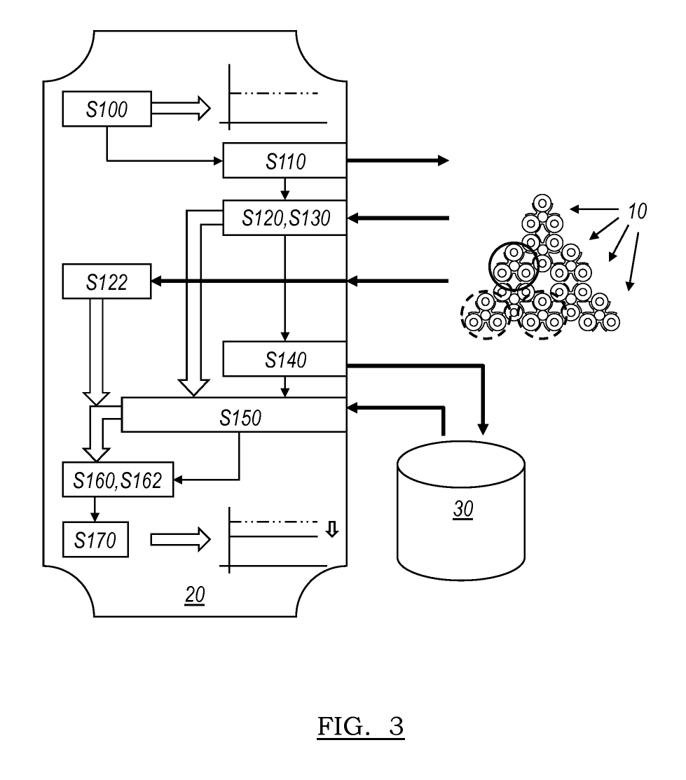

As shown in FIG. 3, determining a second threshold for the module 10 S160 may alternatively include utilizing information from a neighboring (or, more specifically, adjacent) module 10. Information from a neighboring module 10 is preferably used to detect potentially harmful operating conditions in neighboring module 10s and, ultimately, to protect the module 10 from daisy-chain reactions such as critical failure of module 10s or thermal runaway between module 10s. In this variation, retrieving data representative of the operating condition of the module 10 S120 preferably also includes retrieving data representative of the operating conditions of neighboring module 10s S122 and determining a second operation threshold for the module 10 S160 includes evaluating neighboring module 10 data for safety S162. The data representative of the operating conditions of the neighboring module 10s S122 may include current operating conditions of the neighboring module 10 and the location of the neighboring module 10, but may also include historical operating conditions of the neighboring module 10s, rate of change of the operating conditions of the neighboring module 10s, and/or age of the neighboring module 10. The data representative of the operating conditions of the neighboring module 10s may also be data representing the overall health of the neighboring module 10, for example, a neighboring module 10 may be detected to be operating at an operating condition beyond an operation threshold (Step S210) and, as a result, that particular module 10 is determined to be “not healthy” in Step S220. The “not healthy” notification is then retrieved in Step S122. Alternatively, the “not healthy” notification may also indicate the problematic operation threshold, for example, the neighboring module 10 may be operating beyond the temperature threshold but is normal otherwise, or the neighboring module 10 may be operating beyond both the temperature and the pressure threshold and is normal otherwise. However, any other information suitable to detect potentially harmful operation of neighboring module 10s may be used. Evaluating neighboring data for safety S162 preferably functions to take the data retrieved in S122 and determining whether the operation of the neighboring module 10 may adversely affect the current module 10. Step S122 preferably detects for certain neighboring operating conditions that may directly damage the current module 10, for example, any operating conditions beyond an operation threshold of a neighboring module 10 and/or any indication of a “not healthy” neighboring module 10. Step S122 may also detect for a relatively high rate of temperature and/or pressure increase of a neighboring module 10, a relatively low voltage output from a neighboring module 10, a relatively high impedance in a neighboring module 10, a relatively high current through a neighboring module 10, and/or relatively high resistance in a neighboring module 10. The above conditions may be detected through the use of thresholds, for example, a threshold for rate or a maximum temperature threshold. The thresholds are preferably inputted into the system by the manufacturer, but may alternatively be inputted by a technician, remotely inputted from the manufacturer, selected from existing operation thresholds for the current module 10, selected from existing operation thresholds for the neighboring module 10, and/or from any other suitable method or source. However, any other type of neighboring operating conditions suitable to indicate conditions in a neighboring module 10 that may damage the current module 10 may be used.

In this variation of Step S160, once a potentially damaging operating condition in a neighboring module 10 is detected, Step S160 preferably functions to determine a second operation threshold relative to the detected potentially damaging operating condition in a neighboring module 10. The second operation threshold determined in Step S160 is preferably a more conservative threshold than the first operation (for example, the operation threshold for second operation threshold for maximum temperature is lower than the first operation threshold for maximum temperature). As a result, the operating conditions of the module 10 will be detected as beyond operation thresholds earlier than if the operation thresholds were less conservative, thereby providing additional protection to the module 10 as a result of potentially damaging operating conditions in a neighboring module 10.

In a first example, the rate of increase in temperature of a neighboring module 10 may be of a relatively high rate. Step S162 determines this to be a potentially damaging operating condition of the neighboring module 10 and, as a result, Step S160 lowers the maximum temperature threshold for the current module 10. The rapidly increasing temperature of the neighboring module 10 then leads to an increase of temperature in the current module 10. Because the maximum temperature threshold for the current module 10 has been decreased, corrective action is applied to the current module 10 in Step S220 (e.g., disconnecting the current module 10) and damage to the current module 10 from the thermal runaway from the neighboring module 10 is prevented. If the temperature threshold of the current module 10 is not decreased, corrective action in Step S220 may come too late to prevent damage to the current module 10 from the thermal runaway from the neighboring module 10.

In a second example, the internal impedance of a neighboring module 10 is detected to be relatively high. Step S160 lowers the maximum current threshold, the maximum voltage threshold, the maximum power output threshold, and/or the maximum temperature threshold to prevent the current module 10 from bearing the extra load that may result from a neighboring module 10 having high impedance and potentially suffering damage. The second operation threshold may also be determined based upon the location of the neighboring module 10. If the neighboring module 10 detected as potentially harmful to the current module 10 is located adjacent to the current module 10 (e.g. electrically adjacent or physically adjacent), the second operation threshold is preferably more conservative than if the neighboring module 10 is not adjacent (e.g. electrical distance or physical distance). Alternatively, the second operation threshold may be less conservative for neighboring modules 10 that are adjacent than those that are not adjacent. However, any other second operation threshold in response to any type of potentially damaging operating conditions of a neighboring module 10 suitable to protect the current module 10 may be used.

Step S160 is preferably one of the variations described above, but may alternatively be any other method and data suitable to managing the power source and module 10 and evaluating the second operation threshold for a module 10.

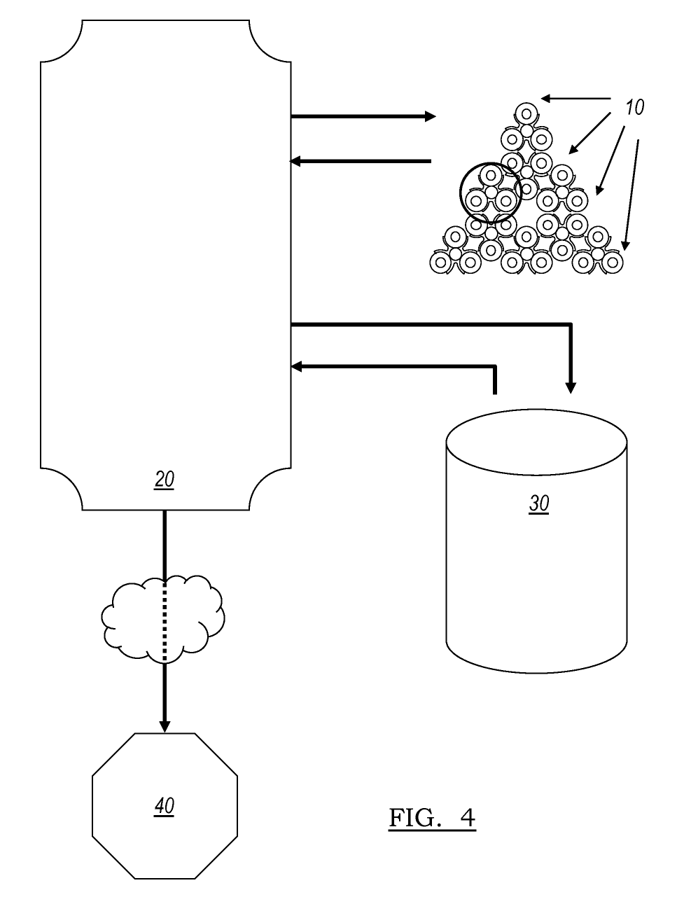

As shown in FIG. 4, the method of the preferred embodiment may further include sending the retrieved data to the manufacturer S180. The data may be used to improve future design iterations of the power source or to understand the performance of distributed power sources. The sent data preferably includes the most recently retrieved data from Steps S120 and S130 and the historical data stored in Step S130, but may alternatively include any other data gathered by the system. The data is preferably sent on a scheduled basis, for example, once a day, once a month, or once in several months. The data may also be split up into divisions to be sent at different times. However, any other suitable frequency or data division may be used. The data is preferably sent wirelessly through a network such as using wi-fi or Bluetooth, but may alternatively be sent through a wired connection such as through Ethernet. However, any other suitable method for sending data may be used. The data may also be sent to a local technician or any other suitable recipient for evaluation and use.

The retrieved data may also be sent to a central processing unit 20 in the system that preferably consolidates the information. The consolidated information may be used to provide a status report to an external recipient 40, for example, a technician, a manufacturer, a display on the device, and/or a remote monitoring system, but may alternatively be sent to any other suitable recipient. The status report may include details regarding the time and the operating conditions of the individual modules 10 within the system at each time, but may alternatively be abbreviated to include the time of occurrences of operating conditions beyond the operation thresholds. The status report may also be a series of indicators on a display that indicate the location of problematic modules 10 on a diagram to facilitate communication with a technician or the user. However, any other medium, level of detail, or method suitable to communicate the overall condition of the system may be used. The information gathered may be used to set the initial operation thresholds of future modules 10 or, in one variation, may be sent to existing modular power sources and used in the determination of the first and/or second operating thresholds.

As a person skilled in the art will recognize from the previous detailed description and from the figures and claims, modifications and changes can be made to the preferred embodiments of the invention without departing from the scope of this invention defined in the following claims.

We claim:

1. A method for managing a modular power source, comprising the steps of:
a) setting an initial operation threshold;
b) for a selected module 10 in the modular power source:
receiving data representative of a present operating condition of the selected module 10;
retrieving data representative of a past operating condition of the selected module 10;
comparing the present data and the past data;
determining a modified operation threshold for the selected module 10 based on the comparison;
applying the modified operation threshold for the selected module 10; and
c) selecting a different module 10 in the modular power source and repeating step (b) for the selected different module 10.

2. The method of claim 1, wherein the step of applying the modified operation threshold includes replacing the initial operation threshold with the modified operation threshold.

3. The method of claim 1 further comprising the steps of detecting the occurrence of an operating condition outside of the operation threshold and, upon such occurrence, adjusting the operation of the module 10.

4. The method of claim 3, wherein the step of adjusting the operation of the module 10 includes at least one step selected from the group consisting of:
disconnecting the module 10;
reconnecting the module 10;
adjusting the required power output of the module 10;
adjusting the charge current supplied to the module 10; and
adjusting the thermal regulation of the module 10.

5. The method of claim 1, further comprising detecting the occurrence of an operating condition outside of the operation threshold and, upon such occurrence, performing the steps of comparing the present data and the past data and determining a modified operation threshold for the selected module 10 based on the comparison.

6. The method of claim 5, wherein the step of comparing the present data and the past data includes determining whether the operating condition provides an increased risk to the module 10, wherein the step of determining a modified operation threshold is at least partially based on the determination of increased risk.

7. The method of claim 6, wherein the step of determining a modified operation threshold for the module 10 includes:
determining to replace the initial operation threshold with a modified operation threshold when the operating condition is determined to not provide an increased risk to the module 10, wherein the modified threshold results in the operating condition no longer outside the operation threshold; and
determining to maintain the initial threshold when the operating condition is determined to provide an increased risk to the module 10.

8. The method of claim 7, wherein the step of determining a modified operation threshold for the module 10 further includes adjusting the operation of the module 10 when the operating condition is determined to provide an increased risk to the module 10.

9. The method of claim 6, wherein the step of setting an initial operation threshold includes setting a second initial operation threshold, wherein the step of retrieving data representative of the operating condition of the module 10 includes retrieving data representative of a second operating condition, and wherein the step of determining whether the operating condition provides an increased risk to the module 10 includes the steps of:
detecting the occurrence of the second operating condition outside of the second operation threshold;
indicating that the operating condition provides an increase in risk when the second operating condition is outside of the second operation threshold.

10. The method of claim 9, wherein determining whether the operating condition provides an increased risk to the module 10 further includes:
evaluating the past data and detecting a past occurrence of the second operating condition outside of the second operation threshold while the operating condition was also detected as outside the operation threshold; and
indicating that the operating condition provides an increase of risk when a past occurrence of the second operating condition outside of the second operation threshold while the operating condition was also detected as outside of the operation threshold is detected.

11. The method of claim 1, wherein the step of applying the modified operation occurs at a time selected from the group consisting of: upon first use of the power source, upon first use of the selected module 10 within the power source, upon start of each discharge cycle of the power source, upon start of each charge cycle of the selected module 10, upon first use of the power source after a re-arrangement of the modules 10, upon start of each discharge cycle of the selected module 10, and upon start of each charge cycle of the selected module 10.

12. The method of claim 1, wherein the initial and modified operation thresholds are values for an operation parameter selected from the group consisting of voltage, current, temperature, internal impedance, power capacity, pressure, energy capacity, and time.

13. The method of claim 1, wherein the initial and modified operation thresholds are trends for an operation parameter based on module 10 characteristics selected from the group consisting of: the age of the module 10 and discharge cycles of the module 10.

14. The method of claim 1, wherein the initial and modified operation thresholds are thresholds indicating maximum allowable deviation from the average operating conditions of the modular power source.

15. The method of claim 1, wherein the data representative of the operating condition of the module 10 include a value for an operation parameter.

16. The method of claim 15, wherein the value for an operation parameter is selected from the group consisting of: voltage, current, temperature, internal impedance, power capacity, and pressure.

17. The method of claim 1, wherein the data representative of the operating condition of the module 10 further includes a time element selected from the group consisting of: time data relative to an initial use of the module 10, time data relative to a first use of the module 10 after the most recent discharge cycle, and time data relative to a first use of the module 10 after the most recent charge cycle.

18. The method of claim 1, wherein the step of setting an initial operation threshold includes a rate of change threshold; wherein the step of comparing includes calculating a rate of change within a time frame for the operating condition; and wherein the step of determining a modified operation threshold includes:
determining a modified operation threshold of a first level when the rate of change of the operating condition is greater than the rate of change threshold; and
determining a modified operation threshold of a second level different than the first level when the rate of change of the operating condition is less than the rate of change threshold.

19. The method of claim 1, further comprising the step of retrieving data representative of the operating condition of an adjacent module 10; and wherein the step of determining the modified operation threshold is at least partially based on the retrieved data representative of the adjacent module 10.

20. The method of claim 19, further comprising the step of determining whether the operating conditions in adjacent modules 10 provide an increased risk to the selected module 10; wherein the step of determining the second operation threshold is at least partially based on the determination of increased risk.

21. The method of claim 19, wherein the data representative of the operating condition of an adjacent module 10 is selected from the group consisting of: location of the adjacent module 10, the rate of change of an operation parameter of the adjacent module 10, age of the adjacent module 10, data representing the overall health of the adjacent module 10, and notification of an operating condition outside of an operation parameter.

22. The method of claim 19, wherein the step of determining whether the operating conditions in adjacent modules 10 provide an increased risk includes evaluating an operating condition outside of an operation threshold.

23. The method of claim 19, wherein the step of determining whether the operating conditions in adjacent modules 10 provide an increased risk include evaluating an operating condition selected from the group consisting of: temperature increase of a rate greater than a threshold temperature increase rate, pressure increase of a rate greater than a pressure increase rate, a voltage output lower than a threshold minimum voltage output, an internal impedance greater than a threshold maximum internal impedance, and a current greater than a threshold maximum current.
